(19) United States
(12) Patent Application Publication
(10) Pub. No.: US 2015/0167729 A1
(43) Pub. Date: Jun. 18, 2015

(54) METHOD FOR ATTACHING SUCKER

(71) Applicant: SHARP CHEMICAL IND. CO., LTD., Osaka (JP)

(72) Inventors: Yasuhiro KASAHARA, Sakai-shi (JP); Hiromu NAGAE, Sakai-shi (JP)

(73) Assignee: SHARP CHEMICAL IND. CO., LTD., Osaka (JP)

(21) Appl. No.: 14/567,381

(22) Filed: Dec. 11, 2014

(30) Foreign Application Priority Data
Dec. 16, 2013 (JP) 2013-258832
Sep. 30, 2014 (JP) 2014-201725

(51) Int. Cl. F16B 47/00; C09D 183/06

(52) U.S. Cl. CPC F16B 47/00; C09D 183/06

(57) ABSTRACT

To provide a method for attaching sucker, which is capable to attach the sucker to the sucked surface for a long time and to remove easily the sucker from the sucked surface when the sucker becomes unnecessary. The invention comprises applying a non-adhesive moisture curable resin composition to a suction surface of the sucker, the non-adhesive moisture curable resin composition comprising 100 parts by weight of a polymer (I) having a hydrolyzable silicon group of less than 50% of total molecular terminal group, and 5 to 200 parts by weight of a polymer(II) having a hydrolyzable silicon group of 50% or more of total molecular terminal group, and attaching the sucker by pressing the suction surface against a sucked surface.

### BACKGROUND OF THE INVENTION

The present invention relates to a method for attaching sucker used for attaching an article to a sucked surface such as a wall surface.

The sucker is widely used for attaching an article to water section equipment such as a kitchen, a washroom, and a bath; and an indoor wall surface. A sucker is formed in the shape of a disk with flexible materials such as rubber, and comprises a suction surface which sucks to a sucked surface and a rear surface which is the back side of the suction surface.

Upon pressing a central part of the suction surface of the sucker against the sucked surface, the substantially vacuum condition is generated between the suction surface and the sucked surface, and the vacuum condition is maintained by the elasticity of the sucker, whereby the sucker is sucked and attached to the sucked surface. However, when the sucked surface includes fine unevenness, there is a problem that the adhesion between the suction surface and the sucked surface is decreased and the sucker becomes easy to separate from the sucked surface. Moreover, even when used for water section equipment, there is a problem that the sucker becomes easy to separate from the sucked surface due to its low durability when used for a long time. On this issue, for example, methods such as attaching the sucker by using an adhesive tape including a double-sided tape and adhesives (for example, patent document 1), or fixing the sucker with a screw, are performed.

### PRIOR ART DOCUMENT

### Patent Document

Patent Document: Unexamined Japanese Patent Publication No. 2000-287822

### SUMMARY OF THE INVENTION

However, when a sucker becomes unnecessary, or when it becomes necessary to move the sucker to other place, there is a problem that the sucker cannot be removed easily, or residual of adhesive tape or adhesives is left on the sucked surface when the sucker is removed when using adhesive tape or adhesives. Moreover, when a screw is used, marks of the screw is left on the sucked surface and thereby damaging the sucked surface.

It is an object of the present invention to provide a method for attaching sucker, which is capable to attach the sucker to the sucked surface for a long time and to remove easily the sucker from the sucked surface when the sucker becomes unnecessary.

In order to solve the above problems, there is provided a fixing method for sucker used for attaching an article, the method comprising: applying a non-adhesive moisture curable resin composition to a suction surface of the sucker, the non-adhesive moisture curable resin composition comprising 100 parts by weight of a polymer (I) having a hydrolyzable silicon group of less than 50% of total molecular terminal group, and 5 to 200 parts by weight of a polymer(II) having a hydrolyzable silicon group of 50% or more of total molecular terminal group; and attaching the sucker by pressing the suction surface against a sucked surface.

According to the present invention, it is capable to attach the sucker to the sucked surface for a long time and to remove easily the sucker from the sucked surface when the sucker becomes unnecessary.

### BRIEF DESCRIPTION OF THE DRAWINGS

FIGS. 1A, 1B and 1C are schematic views illustrating one example of the form of a sucker used for the present invention, in which FIG. 1A is a plain view, FIG. 1B is a side view, and FIG. 1C is a cross-sectional view.

### DETAILED DESCRIPTION OF THE PREFERRED EMBODIMENTS

Hereinafter, an exemplary embodiment of the present invention will be described in detail.

The method for attaching sucker of the present invention includes applying a resin composition to a suction surface of the sucker and attaching the sucker by pressing the suction surface to the sucked surface, and a non-adhesive moisture curable resin composition comprising 100 parts by weight of a polymer (I) having a hydrolyzable silicon group of less than 50% of total molecular terminal group, and 5 to 200 parts by weight of a polymer(II) having a hydrolyzable silicon group of 50% or more of total molecular terminal group is used as the above resin composition.

The objective sucked surface of the present invention is not limited in particular only if being used for attaching the sucker. For example, the sucked surface includes a water section equipment such as a kitchen, a washroom, and a bath; and an indoor wall surface. Moreover, a material of the sucked surface includes a solid material such as metal, glass, plastics, a tile, mortar, and wallpaper. Although, conventionally, it has been difficult to attach the sucker to a ground glass even among glass and wallpaper, according to the method of the present invention, the sucker can be attached easily to those sucked surface.

### (Non-Adhesive Moisture Curable Resin Composition)

The non-adhesive moisture curable resin composition employed in the present invention includes a polymer (I) and a polymer (II). A polyoxyalkylene polymer or a vinyl polymer may be used for the main chain of the polymer (I) and (II). A polyoxyalkylene polymer may include a polymer composed of one or more of repeating units selected from —CH₂CH₂O—, —CH₂CH(CH₃)O—, —CH₂CH(C₂H₅)O—, —CH(CH₃)CH₂O—, —CH(C₂H₅)CH₂O—, —CH₂CH₂CH₂O—, and —CH₂CH₂CH₂CH₂O—.

Preferable repeating unit is —CH₂CH(CH₃)O—. Moreover, a vinyl polymer may include polyethylene, polypropylene, polyisobutylene, poly(metha)acrylate, polystyrene, polyvinyl chloride, polyvinylidene chloride, polybutadiene, polyisoprene, polyvinyl acetate, polyvinyl alcohol, polyvinyl butyral, and a copolymer that contains any two or more sorts of these polymers as a component, etc. Preferable vinyl polymer is poly(metha)acrylate.

When a polyoxyalkylene polymer is used for the main chain, the molecular weight of the polymer (I) is 500 to 30,000, preferably 1,000 to 20,000. Moreover, the molecular weight of the polymer (II) is 500 to 30,000, preferably 5,000 to 20,000. Here, the molecular weight of the polymer (I) and (II) is calculated from hydroxyl number.

Moreover, in case that a vinyl polymer is used for the main chain, the number average molecular weights of the polymer (I) are 500 to 30,000, preferably 1,500 to 15,000. Moreover, the number average molecular weights of the polymer (II) are 500 to 30,000, preferably 2,000 to 15,000.

Moreover, as for the polymer (I), the introduction rate of the hydrolyzable silicon group to molecular chain terminals is less than 50%, preferably 25% or more and less than 50%. Moreover, as for the polymer (II), the introduction rate of the hydrolyzable silicon group to molecular chain terminals is 50% or more and 100% or less, and preferably 60% or more and 100% or less. Here, the introduction rate of the hydrolyzable silicon group to molecular chain terminals, in the case of hydroxy-terminated polymer, unreacted hydroxyl group after introduction of the hydrolyzable silicon group may be calculated using a hydroxyl number analytical method. Moreover, as for a method which is not limited to the kind of terminal group, the method may include calculating the introduction rate from the results obtained from the method which determines the terminal group after introduction of the hydrolyzable silicon group by using IR or NMR.

Moreover, as for the hydrolyzable silicon group of the polymer (I) and the polymer (II), alkyldialkoxysilyl group and trialkoxysilyl group may be used. As for alkylalkoxysilyl group, the alkyl group having 1 to 6 carbon atoms is preferable, the alkoxy group having 1 to 6 carbon atoms, that is, methoxy group, ethoxy group, propoxy group, butoxy group, pentyloxy group, or n-hexyloxy group is preferable, and more preferably methyldimethoxysilyl group or methyldiethoxysilyl group, and further more preferably methyldimethoxysilyl group. Moreover, as for trialkoxysilyl group, the alkoxy group having 1 to 6 carbon atoms, that is, methoxy group, ethoxy group, propoxy group, butoxy group, pentyloxy group, and n-hexyloxy group are preferable, and more preferably trimethoxysilyl group. The combination of the hydrolyzable silicon group of the polymer (I) and (II) is not limited particularly.

The polymer (II) is used in amounts ranging from 5 to 250 parts by weight, preferably 5 to 200 parts by weight to 100 parts by weight of the polymer (I). If fewer than 5 parts by weight are used, since the sucker sticks to the glass, it becomes difficult to cleanly remove the sucker from the glass. Contrarily, addition of more than 250 parts by weight, the sucker easily adhere to the glass.

As for a method to introduce hydrolyzable silicon group into a polyoxyalkylene polymer, a well-known method can be used, for example, the method comprising carrying out ring opening polymerization of cyclic ether to produce polyoxyalkylenediol in the presence of a bifunctional initiator, and introducing a hydrolyzable silicon group into the hydroxyl group of this diol. Moreover, as for a method for introducing a hydrolyzable silicon group into a vinyl polymer, a method can be used, which comprising copolymerizing a vinyl monomer and a hydrolyzable silicon group monomer. As for a method for changing the introduction rate of a hydrolyzable silicon group, in the case of a polyoxyalkylene polymer, the introduction rate can be changed by varying the molar number of a hydrolyzable silicon group to the hydroxyl group of the diol. Moreover, in the case of a vinyl polymer, the introduction rate of a hydrolyzable silicon group can be changed by varying the compounding ratio of the hydrolyzable silicon group containing monomer which is to be copolymerized.

### (Curing Catalyst)

A curing catalyst may be used for synthesizing a non-adherent moisture curing type resin composition used for the present invention for promoting a curing reaction. As an example, metal salts such as alkyl titanate, organic silicon titanate, bismuth-tris-2-ethylhexanoate, acidic compounds such as phosphoric acid, p-toluenesulfonic acid, and phthalic acid, and amine compounds including aliphatic monoamines such as butylamine, hexylamine, octylamine, decylamine, and lauryl amine, aliphatic diamines such as ethylenediamine and hexanediamine, aliphatic polyamines such as diethylenetriamine, triethylenetetramine and tetraethylenepentamine, heterocyclic amines such as piperidine and piperazine, aromatic amines such as meta-phenylenediamine, ethanolamines, triethylamine, and various modified amines used as a curing agent of an epoxy resin. Moreover, a mixture of bivalent tin such as tin dioctylate, tin dinaphtenate and tin distearate, and the above amine may be used.

Moreover, dibutyltin diacetate, dibutyltin dilaurate, dioctyltin dilaurate, and the following carboxylic type organic tin compounds, and a mixture of these carboxylic type organic tin compounds and the above amines may be used.

(n-C₄H₉)₂Sn(OCOCH═CHCOOCH₃)₂
(n-C₄H₉)₂Sn(OCOCH═CHCOO-(n-C₄H₉))₂
(n-C₈H₁₇)₂Sn(OCOCH═CHCOOCH₃)₂
(n-C₈H₁₇)₂Sn(OCOCH═CHCOO-(n-C₄H₉))₂
(n-C₈H₁₇)₂Sn(OCOCH═CHCOO-(iso-C₈H₁₇))₂

Moreover, the following sulfur containing type organic tin compounds may also be used.

(n-C₄H₉)₂Sn(SCH₂COO)
(n-C₈H₁₇)₂Sn(SCH₂OOO)
(n-C₈H₁₇)₂Sn(SCH₂CH₂COO)
(n-C₈H₁₇)₂Sn(SCH₂COOCH₂CH₂OCOCH₂S)
(n-C₄H₉)₂Sn(SCH₂COO-(iso-C₈H₁₇))₂
(n-C₈H₁₇)₂Sn(SCH₂COO-(iso-C₈H₁₇))₂
(n-C₈H₁₇)₂Sn(SCH₂COO-(n-C₈H₁₇))₂
(n-C₄H₉)₂SnS

Moreover, the following organic tin oxide may also be used.

(n-C₄H₉)₂SnO
(n-C₈H₁₇)₂SnO

Moreover, a reaction product of the above organic tin oxide and ester compounds such as ethyl silicate, dimethyl maleate, diethyl maleate, dioctyl maleate, dimethyl phthalate, diethyl phthalate, and dioctyl phthalate, may also be used.

Moreover, the following chelate tin compounds, and a reaction product of these chelate tin compounds and alkoxy silane (“acac” represents an acetylacetonate ligand), may also be used.

(n-C₄H₉)₂Sn(acac)₂
(n-C₈H₁₇)₂Sn(acac)₂
(n-C₄H₉)₂(C₈H₁₇O)Sn(acac)

Moreover, the following —SnOSn— bond containing organic tin compounds may also be used.

(n-C₄H₉)₂(CH₃COO)SnOSn(OCOCH₃)(n-C₄H₉)₂
(n-C₄H₉)₂(CH₃O)SnOSn(OCH₃)(n-C₄H₉)₂

A curing catalyst is used in amounts ranging from 0.01 to 10 parts by weight to the total 100 parts by weight of the polymer (I) and (II). If fewer than 0.01 pats by weight, an effect is not enough, and if more than 10 parts by weight, it is not desirable since the durability decreases.

Additives such as a filler, a dehydrating agent and a plasticizer may be added to the moisture curing type resin composition used for the present invention may include when necessary.

### (Filler)

A well-known filler may be used. Suitable fillers may include a powdery filler such as calcium carbonate including calcium carbonate whose surface is treated with fatty acid or a resin acid organic substance, colloidal calcium carbonate with a mean particle diameter of 1 micrometer or less obtained by finely pulverizing the above calcium carbonate, precipitated calcium carbonate with a mean particle diameter of 1-3 micrometers produced by using precipitation method, and heavy calcium carbonate with a mean particle diameter of 1-20 micrometers, fumed silica, sedimentation silica, a silicic acid anhydride, hydrous silicic acid, carbon black, magnesium carbonate, a diatomaceous soil, calcination clay, clay, talc, titanium oxide, bentonite, organic bentonite, ferric oxide, zinc oxide, an active zinc oxide, shirasu balloon, wood flour, pulp, cotton chip, mica, walnut shell powder, chaff powder, graphite, aluminum powder, and flint powder, and a fibrous filler such as glass fiber, glass filament, carbon fiber, Kevlar fiber, and a polyethylene fiber. These fillers may be used alone or in combination of two or more.

The amount of the filler used is 1 to 1000 weight percent to the total amount of the polymer (I) and (II), and preferably is 10 to 300 weight percent.

### (Plasticizer)

A plasticizer may also be used for the non-adherent moisture curing type resin composition used for the present invention for adjusting hardness. A well-known plasticizer may be used. Suitable plasticizers may include phthalic acid alkyl ester such as dioctyl phthalate, dibutyl phthalate, and butyl benzyl phthalate, aliphatic carboxylic acid alkyl ester such as dioctyl adipate, diisodecyl succinate, dibutyl sebacate, and butyl oleate, pentaerythritol esters, phosphoric acid ester such as trioctyl phosphate, and tricresyl phosphate, epoxy plasticizers such as epoxidized soybean oil, and benzyl epoxystearate, polypropylene glycol, polyethylene glycol, chlorinated paraffin, and the like. These plasticizers may be used alone or in combination of two or more.

### (Dehydrating Agent)

In order to adjust properties, curability, and storage stability of a cured material, a hydrolyzable silicon compound may be arbitrarily added to a non-adherent moisture curing type resin composition used for the present invention. Suitable hydrolyzable silicon compounds may include, but are not limited to, tetramethylsilicate, vinyltrimethoxysilane, methyltrimethoxysilane, dimethyldimethoxysilane, trimethylmethoxysilane, and those compounds whose methoxy group is substituted by ethoxy group. The addition amount is 0.5 to 5 parts by weight to 100 parts by weight of the polymer (I) and (II). If fewer than 0.5 parts by weight, storage stability will deteriorate. Contrarily, if more than 5 parts by weight, the sucker easily adhere to the glass.

As other additives, a thixotropy imparting agent, a phenol resin and an epoxy resin, a pigment, various kinds of stabilizers, an aging preventing agent, an ultraviolet absorbing agent, a photocurable compound such as oligoester acrylate aiming at surface treatment, and a solvent for adjusting viscosity, and the like may also be added. However, a tackifier such as various silane coupling agents generally used in a moisture curing resin composite is not added.

Moreover, a solvent may also be used in order to adjust viscosity.

Moreover, the non-adherent moisture curing type resin composition used for the present invention may be cured under an environmental condition, and curing may be promoted by heating or adding water.

Moreover, as for the non-adherent moisture curing type resin composition used for the present invention, it is preferable that a thixotropy ratio of the resin composition which is defined by the ratio of the viscosity in 2 rpm measured using a B type rotational viscometer to the viscosity in 10 rpm measured using a B type rotational viscometer is 2.5 or more, and the viscosity in 10 rpm is 100 Pa·s or more. It is preferable that the thixotropy ratio is 2.5 to 4.0. Here, the thixotropy ratio may be represented by V_{2 rpm}/V_{10 rpm}, when the viscosity in 2 rpm and 10 rpm is set to V_{2 rpm} and V_{10 rpm}, respectively. The resin composition having the thixotropy ratio is 2.5 or more, and the viscosity in 10 rpm is 100 Pa·s or more can prevent liquid dripping when applying the resin composition to the suction surface.

Further, the non-adherent moisture curing type resin composition used for the present invention may be used for a double-sided tape, in which the resin composition is applied to one or both sides of a support made of synthetic resin film such as polyester, polyethylene, polypropylene, polystyrene, and polyamide.

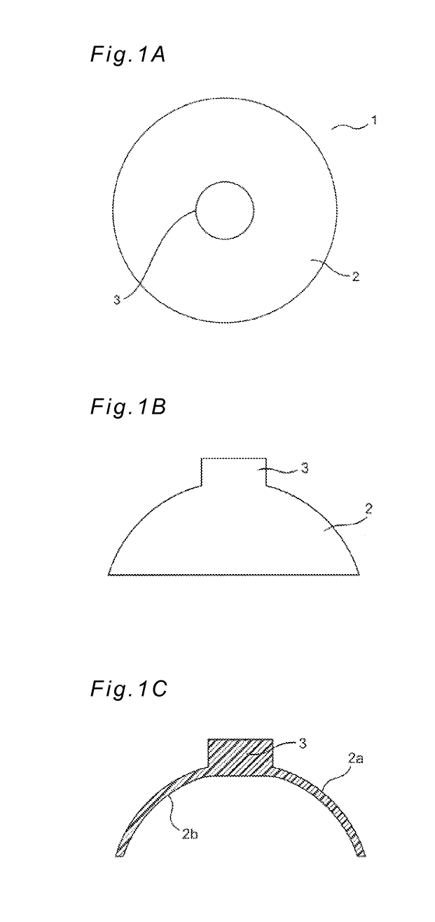

FIGS. 1A, 1B, and 1C are a schematic views illustrating one example of the form of a sucker used for the present invention, in which FIG. 1A is a plain view, FIG. 1B is a side view, and FIG. 1C is a cross-sectional view. A sucker 1 includes a dish-like shaped main body 2 and a projection 3 formed at the roughly center part of the main body 2. The main body 2 includes a suction surface 2b as one surface in the thickness direction which adheres to a sucked body (not shown), and a rear surface 2a as the other surface in the thickness direction. The projection 3 is formed on the rear surface 2a. The main body 2 which is made of a well-known material such as a natural rubber, a synthetic rubber, and a synthetic resin material having elasticity may be used. Moreover, the projection serves to fix an article holder such as a hook, and may be formed of a material harder than that of the main body 3. The projection 3 may be formed integrally with the main body 3, or may be formed separately and fixed to the main body 3 by fitting or adhesion.

When attaching the sucker to the sucked body, the above non-adherent moisture curing type resin composition is applied to at least a portion of the suction surface 2b, then the main body 3 is pressed against the sucked surface so that a dish is turned over, and thereby to recess the main body 3, and to attach the sucker 1. The use of the above non-adherent moisture curing type resin composition makes it possible to attach the sucker to a non-flat sucked surface, and also to remove the sucker easily when the sucker becomes unnecessary or when moving the sucker to somewhere else.

FIG. 1A-1C show the example where the shape of the main body of the sucker is a circular dish-like shape, whereas the shape of the main body of the sucker is not particularly restricted only if the shape of the main body is a dish-like 20′ shape. The main body may have various shapes including a circle, a rectangle, a polygon, an infinite form, an animal, or vegetation and various forms of article. Moreover, the main body may have one or more of openings having fixed forms or infinite forms. In addition, the dish-like shape is defined in this specification as a shape having a recess formed at least at the center part of the suction surface of the main body of the sucker.

### EXAMPLES

Hereinafter, the present invention will be described by way of examples, but the present invention is not limited to the following examples. In addition, the “part” in the following examples represents a “weight part”, unless indicated to the contrary.

### (Synthetic Method of Non-Adherent Moisture Curing Type Resin Composition)

Excestar S1000N (obtained from Asahi Glass Co., Ltd.) and ARUFON US6110 (obtained from Toagosei Co., Ltd.) were used as polymer (I), and Excestar S2420 and Excestar A2551 were used as polymer (II). The hydrolyzable silicon group of Excestar S2420 and Excestar A2551 are fundamentally dialkoxyalkylsilane and trialkoxysilane, respectively. Polypropylene glycol as a plasticizer and silica whose moisture is removed by heating as a filler were added to these polymers, and those were agitated and mixed using the planet type stirrer (manufactured by Kurabo Industries, Ltd.). The obtained mixture was cooled to the room temperature, and then a silane compound as a dehydrating agent and dibutylti-bis(acetylacetonate) were added to the mixture, and the mixture was agitated and mixed, and thereby obtaining the nonadherent moisture curing type resin composition. Formulations of the examples 1-5 and the comparative examples 1-3 are shown in Table 1.

### [Table 1]

### (Test of Non-Adhesiveness to Glass)

After placing the produced resin composition to a glass plate at 23° C. and a humidity atmosphere of 55% and curing for three days, a test piece was subjected to a simple adhesion test (based on the method described in “Handbook of sealant for construction” published by Japan Sealant Industry Association). The case where the resin composition was easily removed without leaving marks was determined to be acceptable (◯), and the case where even a few marks were left was determined to be unacceptable (x).

### (Curability Test)

After placing the produced resin composition to an aluminum channel having a width of 10 mm and a height of 10 mm at 23° C. and a humidity atmosphere of 55%, a thickness (unit: mm) of a test piece which was cut down after 24 hours was measured. If its thickness is 0.5 mm or more, the resin composition could have a curing rate which is within the range of causing no problem in a practical use.

### (Sucker Attaching Test)

### Attaching Test 1

The produced resin composition was applied to the suction surface of the sucker of a commercial flow brush pocket (with a sucker) (manufactured by Inomata Chemical Co., Ltd.), and the sucker was closely fitted to a ground glass. A weight with 1 kg weight was placed on the pocket on the next day, and the pocket was left as it is for a week. Then, the sucker was removed and the exfoliation state was determined based on the following evaluation criteria.

◯: The position of the sucker was not changed and the sucker was cleanly removed from the glass surface.
x: Although the position of the sucker was not changed, some resin composition remained on the glass surface after removing the sucker.
x x: The position of the sucker was changed from the original position (including falling).
x x x: The sucker could not be attached even without a weight.

### Attaching Test 2

The produced resin composition was applied to the suction surface of the sucker of a commercial Q-BAN ring hanger (manufactured by Yamada Chemical Co., Ltd., a ring hanger with a sucker, 500 g of load bearing capacity), and the sucker was closely fitted to a mortar wall. A weight with 1 kg weight was placed on the next day, and the sucker was left as it is for a week. Then, the sucker was removed and the exfoliation state was determined based on the following evaluation criteria.

◯: The sucker position was not changed and the sucker was cleanly removed from the mortar surface.
x: Although the sucker position was not changed, some resin composition remained on the mortar surface after removing the sucker
x x: The position of the sucker was changed from the original position (including falling).
x x x: The sucker could not be fixed even without a weight.

### Attaching Test 3

The produced resin composition was applied to the suction surface of the sucker of a commercial mini sucker hook (H-099) (the sucker hook manufactured by LEC, Inc., 500 g of load bearing capacity), and the sucker was closely fitted to an indoor wallpaper. A weight with 1 kg weight was placed on the next day, and the sucker was left as it is for a week. Then, the sucker was removed and the exfoliation state was determined based on the following evaluation criteria.

◯: The sucker position was not changed and the sucker was easily removed from the wallpaper surface.
x: Although the sucker position was not changed, some resin composition remained on the wallpaper surface after removing a sucker.
x x: The position of the sucker was changed from the original position (including falling).
x x x: The sucker could not be fixed even without a weight.

### Attaching Test 4

The produced resin composition was applied to the suction surface of the sucker of a commercial feeling sponge holder (with a sucker) (manufactured by Inomata Chemical Co., Ltd., 500 g of load bearing capacity), and the sucker was closely fitted to a tile wall including tile joint. A weight with 1 kg weight was placed on the next day, and the sucker was left as it is for a week. Then, the sucker was removed and the exfoliation state was determined based on the following evaluation criteria.

◯: The sucker position was not changed and the sucker was easily removed from the tile wall surface.
x: Although the sucker position was not changed, some resin composition remained on the tile wall surface after removing a sucker.
x x: The position of the sucker was changed from the original position (including falling).
x x x: The sucker could not be fixed even without a weight.

### (Result)

Table 2 shows the results of the curability test of examples and comparative examples and also the results of attaching tests 1-4. All of the examples 1-5 exhibited excellent properties in curability and fixing ability. On the other hand, since the polymer (I) was not blended, the comparative example 1 exhibited excellent curability, however, in the fixation test to the ground glass, some resin composition adhered on the ground glass, and the sucker could not be cleanly removed. Moreover, although the polymer (I) was blended, since there was a small amount of the polymer (II), the comparative example 2 had the insufficient curability for practical use in which the thickness of the cured resin composition is less than 0.5 mm, and the position of the sucker was changed in the fixation test. Although the comparative example 3 includes both of the polymer (I) and the polymer (II), since the amount of the polymer (II) was large such that its amount was 300 parts by weight to 100 parts by weight of the polymer (I), some resin composition adhered on the ground glass and the sucker could not be cleanly removed after removing the sucker in the fixation test to the ground glass. Further, the comparative example 4 in Table 2 is a case in which the sucker is directly fitted to a ground glass surface, a mortar wall surface, indoor wallpaper, or a tile wall including tile joint, without applying the resin composition to the suction surface of the sucker. In the comparative example 4, the sucker could not be attached to the surface to be attached in the attaching tests 1-3, even without a weight. Further, in the attaching test 4, the sucker peeled off and dropped at a moment when the weight was placed on the next day.

### [Table 2]

### [Explanation of Signs]

1 sucker
2 main body
2a suction surface
2b rear surface
3 projection

TABLE 1

| | | | | | | Comparative | Comparative | Comparative |
|---|---|---|---|---|---|---|---|---|
| Composition | Example 1 | Example 2 | Example 3 | Example 4 | Example 5 | Example 1 | Example 2 | Example 3 |
| Polymer(I): S1000N: | 100 | 100 | 100 | 100 | 0 | 0 | 100 | 100 |
| US6110 | | | | | | | | |
| | 0 | 0 | 0 | 0 | 100 | 0 | 0 | 0 |
| Polymer(II): S2420: | 90 | 200 | 10 | 0 | 0 | 100 | 0 | 300 |
| A2551 | | | | | | | | |
| | 10 | 0 | 0 | 10 | 10 | 10 | 1 | 0 |
| Plasticizer: | 0 | 0 | 75 | 75 | 75 | 75 | 75 | 0 |
| polypropylene glycol | | | | | | | | |
| Filler: silica | 25 | 30 | 25 | 25 | 25 | 25 | 25 | 30 |
| Dehydrating agent: | 4 | 4 | 4 | 4 | 4 | 4 | 4 | 4 |
| vinyltrimethoxysilane | | | | | | | | |
| Curing catalyst: | 3 | 3 | 3 | 3 | 3 | 3 | 3 | 3 |
| dibutyltin- | | | | | | | | |
| bis(acetylacetonate) | | | | | | | | |

TABLE 2

| | | | | | | Comparative | Comparative | Comparative | Comparative |
|---|---|---|---|---|---|---|---|---|---|
| | Example 1 | Example 2 | Example 3 | Example 4 | Example 5 | Example 1 | Example 2 | Example 3 | Example 4 |
| Curability test | 4 | 2.5 | 0.5-1 | 1 | 3 | 2 | <0.5 | 3 | — |
| Attaching test 1 | ◯ | ◯ | ◯ | ◯ | ◯ | X | X X | X | X X X |
| Attaching test 2 | ◯ | ◯ | ◯ | ◯ | ◯ | ◯ | X X | ◯ | X X X |
| Attaching test 3 | ◯ | ◯ | ◯ | ◯ | ◯ | ◯ | X X | ◯ | X X X |
| Attaching test 4 | ◯ | ◯ | ◯ | ◯ | ◯ | ◯ | X X | ◯ | X X |

1. A method for attaching sucker used for attaching an article, the method comprising:
applying a non-adhesive moisture curable resin composition to a suction surface of the sucker, the non-adhesive moisture curable resin composition comprising 100 parts by weight of a polymer (I) having a hydrolyzable silicon group of less than 50% of total molecular terminal group, and 5 to 200 parts by weight of a polymer(II) having a hydrolyzable silicon group of 50% or more of total molecular terminal group; and
attaching the sucker by pressing the suction surface against a sucked surface.

2. The method according to claim 1, wherein the hydrolyzable silicon group of the polymer (II) contained in the non-adhesive moisture curable resin composition is a trialkoxysilyl group.

3. The method according to claim 1, wherein a thixotropy ratio of the non-adhesive moisture curable resin composition which is defined by the ratio of the viscosity in 2 rpm measured using a B type rotational viscometer to the viscosity in 10 rpm is 2.5 or more, and the viscosity in 10 rpm is 100 Pa·s or more.

4. The method according to claim 2, wherein a thixotropy ratio of the non-adhesive moisture curable resin composition which is defined by the ratio of the viscosity in 2 rpm measured using a B type rotational viscometer to the viscosity in 10 rpm is 2.5 or more, and the viscosity in 10 rpm is 100 Pa·s or more.
